(19) United States
(12) Patent Application Publication
(10) Pub. No.: US 2007/0098476 A1
(43) Pub. Date: May 3, 2007

(54) Drive mechanism for a feed roller in a printer

(75) Inventors: Barry B. Goeree, Venlo (NL); Jacob A. Westdijk, Waalre (NL); Jeroen J.G. Coenen, Venray (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V., Venlo (NL)

(21) Appl. No.: 11/588,250

(22) Filed: Oct. 27, 2006

(30) Foreign Application Priority Data
Oct. 27, 2005 (EP) 05110070.9

(51) Int. Cl. B41J 13/02

(52) U.S. Cl. 400/636

(57) ABSTRACT

A drive mechanism for a feed roller in a printer, which includes a worm wheel connected to the feed roller and forming a rotary unit therewith, a worm engaging said worm wheel, a motor driving said worm, an encoder detecting increments (δφ) in an angular position of the worm, and a servo controller for the motor, wherein the rotary unit has a sync mark defining a reference position (φ0), a reference detector is provided for detecting the sync mark, and said servo controller has access to a calibration memory and is adapted to output a calibrated motor control signal (C) dependant on the angular position of the feed roller as determined from said reference position (φ0) and said worm angular position increments (δφ).

This application claims priority under 35 U.S.C. § 119(a) on Patent Application No. 05110070.9 filed in Europe on Oct. 27, 2005, the entire contents of which is hereby incorporated by reference.

### BACKGROUND OF THE INVENTION

The present invention relates to a drive mechanism for a feed roller in a printer, comprising a worm wheel connected to the feed roller to form a rotary unit therewith, a worm engaging the worm wheel, a motor for driving said worm, an encoder for detecting increments in angular position of the worm gear, and a servo controller for the motor.

In a scanning-type printer, a feed roller is frequently used for advancing a sheet of paper or any other recording medium in a specified direction past a printhead, so that the recording medium can be scanned with the printhead. The speed or the length of the advance steps with which the sheet is moved relative to the printhead must accordingly be controlled with high accuracy, in order to obtain a good image quality. For example, in a typical set-up of an inkjet printer, a multi-nozzle printhead is mounted on a carriage which travels across the recording medium sheet in a main scanning direction, normal to the direction of sheet advance, so that an image swath of several pixel lines is printed on the sheet in each pass of the printhead. Then, the sheet is advanced by the width of the swath, so that the next swath can be printed in a position precisely adjoining to the previous swath. In this case, the width of the sheet advance steps must be controlled with sufficient accuracy so that the adjacent swaths are perfectly “stitched” together and will neither overlap nor form a gap. If the resolution of the printer is 600 dpi, for example, the width of a single pixel line is only 42 μm, and the tolerances allowed for the length of the sheet advance step must even be significantly smaller than this.

A worm-type drive mechanism has the advantage that it provides a high transmission ratio, so that the speed of revolution of the worm is much larger that that of the feed roller. As a consequence, the sheet advance increments provided by the feed roller amount only to a small fraction of the angular increments of the worm, so that a high control accuracy can be achieved by counting the worm increments.

Ideally, there is a linear relationship between the speed of revolution of the worm and the sheet advance speed. In practice, however, some periodic non-linearities come into play, which are due, for example, to eccentricities of the feed roller, the worm wheel, the worm and/or an encoder disk detecting the angular increments of the worm.

### SUMMARY OF THE INVENTION

It is an object of the present invention to provide a drive mechanism which can be calibrated so as to compensate for non-linearities associated with a feed roller in a printer.

To this end, the drive mechanism of the type indicated above includes a rotary unit which has a sync mark for defining a reference position; a reference detector is provided for detecting the sync mark, and a servo controller has access to a calibration memory and is adapted to output a calibrated motor control signal dependent on the angular position of the feed roller as determined from said reference position and the worm angular position increments.

Thus, the non-linearities in the relation between the angular speed of the worm and the sheet advance speed may once be measured and may be stored in the calibration memory, e. g., in the form of a table, so that the control signal supplied to the motor can be calibrated with reference to this table. When the printer is operated, it is a prerequisite for the calibration process, that the current angular position of the feed roller is known, so that the pertinent correction or calibration data may be looked-up in the table. This is achieved by detecting the sync mark on the rotary unit that is formed by the feed roller and the worm wheel at least once in the start-up procedure of the printer. This sync mark defines a specific reference position for the rotary unit, and all other angular positions of the rotary unit can then be derived by relating the count pulses of the encoder to the detected reference position. Then, by reference to the calibration data stored in the calibration memory, it is possible to compensate for all the periodic non-linearities that are due to excentricities or other manufacturing errors of all the rotating components in the drive mechanism.

In a preferred embodiment, the sync mark is provided on an end face of the worm wheel. For example, the sync mark may be in the form of a gap or slot in an annular boss on the end face of the worm wheel, and the reference detector may be an optical detector, e. g., a light barrier, for detecting the gap.

Preferably, the encoder used for detecting the angular increments of the worm is configured as a quadrature encoder which permits detection of not only the angular increments with high resolution but also the direction in which the worm is rotated.

A reference position register may be provided for storing the reference position of the rotary unit. When the printer is started, the motor is driven to rotate the feed roller, and the corresponding pulses of the encoder are counted. At some instant during the first complete revolution of the feed roller, the sync mark will be detected, and the count value that has been reached at that instant is stored in the reference position register.

Then, by continuing to count the increments (or decrements) of the angular position of the worm, as indicated by the encoder pulses, while the feed roller is rotated, it is possible at any time to determine the exact angular position of the feed roller by subtracting the content of the reference position register from the current count value. The angular position of the feed roller thus obtained may then be used for calibration purposes. This procedure for determining the reference position has the advantage that it may be admitted that the angular position of the feed roller is unknown when the power supply for the printer is switched on and the printer is started.

### BRIEF DESCRIPTION OF THE DRAWINGS

A preferred embodiment of the present invention will now be described in conjunction with the drawings, in which:

FIG. 1 is a schematic perspective view of drive mechanism according to the present invention;

FIG. 2 is a diagrammatic representation of a calibration function; and

FIG. 3 is a block diagram of a control and calibration system for the drive mechanism.

### DETAILED DESCRIPTION OF THE INVENTION

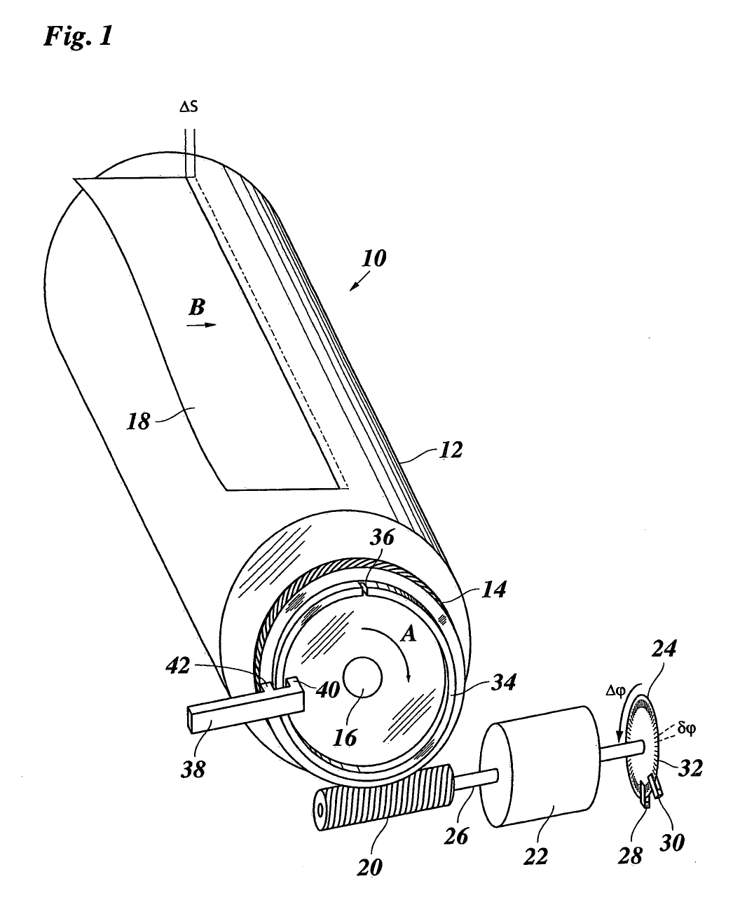

As is shown in FIG. 1, a rotary unit 10 of a printer, i. e., an inkjet printer, comprises a feed roller 12 and a worm wheel 14 mounted for joint rotation on a common axle 16. When the rotary unit 10 is rotated in the direction of an arrow A, a sheet 18 of a recording medium, e. g., paper, is advanced in a direction B relative to a printhead (not shown) of the printer. The direction B may be considered to be a sub-scanning direction of the printer.

A worm 20 is mounted to mesh with the worm wheel 14 and is driven by an electric motor 22. A disk-type encoder 24 is mounted on a drive shaft 26 of the motor 22 so as to detect angular increments δφ by which the worm 20 is rotated. The encoder 24 is configured as a quadrature encoder and has two sensors 28, 30 that are arranged at the periphery of the encoder 24 for detecting the passage of slots 32 of the encoder. As is known in the art, each sensor 28 will output a pulse signal with a rectangular wave form representing the passage of the slots 32, and an angular offset between the sensors 28 and 30 is selected such that the two wave forms are phase-shifted by a quarter period. Thus, it is possible to determine the direction in which the worm 20 is rotated by distinguishing which of the pulses of the sensors 28, 30 come first. By way of example, the encoder 24 may have 500 slots, so that, utilizing the rising and falling edges of the pulses of both sensors 28, 30, it is possible to detect the angular increments with a resolution of 2000 per revolution.

The worm gear formed by the worm 20 and the worm wheel 14 provides a very small transmission ratio k <<1, so that a relatively large angular displacement Δφ of the worm 20 leads only to a relatively small advance interval ΔS for the sheet 18. Thus, in principle, the encoder 24 permits a fine control of the sheet advance with very high accuracy.

Ideally, the function S(φ) relating the sheet advance S to the angular displacement φ of the worm 20 is a linear function:
S(φ)=kφ.

Thus, in order to perform a required sheet advance step Δs, the motor 22 must be controlled to rotate the worm 20 by an angle:
Δφ=ΔS/k.

In practice, however, the function S(φ) includes certain non-linearities which are due, for example to eccentricities of the feed roller 12 and/or the worm wheel 14, to eccentricities of the worm 20 and/or the encoder 24, and possibly also to machining inaccuracies in the helical teeth of the worm 20 and the worm wheel 14. As a result, the function S(φ) has the form
S(φ)=kφ+δ(φ)
wherein δ(φ) reflects the non-linearities.

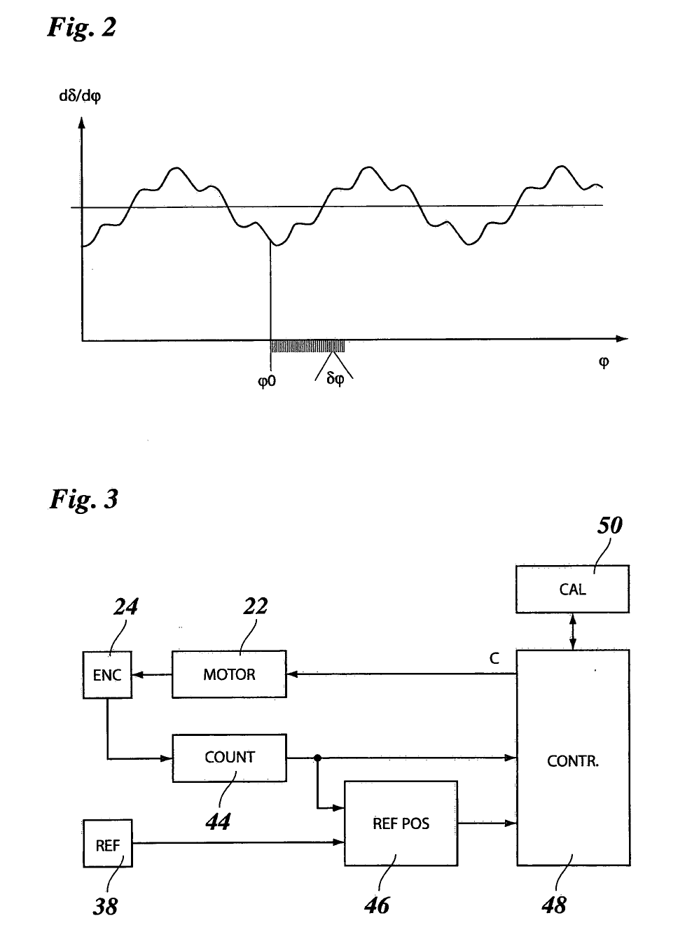

If the transmission ratio k is a rational number, the function δ(φ) is periodic. More specifically, if 1/k is an integer, δ(φ) is a periodic function with a fundamental period corresponding to one complete resolution of the feed roller 12, but may also include higher harmonics, especially one corresponding to a complete revolution of the worm 20. Then, we have:
ΔS=(dS/dφ)Δφ=(+dδ/dφ) Δφ
and
Δφ=ΔS/(k +dδ/dφ)
wherein dδ/dφ is a periodic function, an example of which has been shown in FIG. 2.

Thus, for any desired sheet advance step ΔS, a corresponding angular displacement Δφ of the worm 20, calibrated so as to eliminate the non-linearities, can be calculated from the above formula if the value of dδ/dφ is known for the current angular position of the feed roller 12. More specifically, what should be known are the function dδ/dφ on an interval ranging over a complete revolution period of the feed roller 12, i. e., 1/k complete revolutions of the worm 20, and a reference position φ0 permitting to determine the current angular position of the feed roller 20 within that interval.

As is shown in FIG. 1, an end face of the worm wheel 14 is provided with an annular boss 34 that is concentric with the axle′16 and is interrupted by a single gap 36 at a specific angular position. An optical reference detector 38 for detecting the gap 36 has two legs 40, 42 which embrace the boss 34 and include a light emitting element and a light detecting element, respectively. Thus, the detector 38 will deliver a pulse signal when the gap 36 passes through between the legs 40 and 42. This permits detection of the reference position φ0.

FIG. 3 illustrates a control system for the drive mechanism described above.

The motor 22 drives the worm 20 and also the encoder 24. The pulses of the encoder 24 are counted in a counter 44 which supplies the count values to a reference position register 46, e. g., a 16 bit register, and to a servo controller 48 which calculates a control signal C for controlling the angular displacement Δφ of the motor 22 in accordance with the required sheet displacement ΔS. The servo controller 48 includes or is connected to a calibration memory 50 storing the function dδ/dφ. The reference position register 46 has an input connected to the reference detector 38.

When the power supply for the printer and the control system is switched on, it should be assumed that the angular position of the feed roller 12 is unknown, because it cannot been excluded that the feed roller has been forcibly rotated while the power was switched off. For this reason, the counter 44 and the reference position register 46 are reset in a start-up procedure. Then, the motor 22 is started and rotates the feed roller 12. As soon as the gap 36 passes the detector 38 in the first revolution of the feed roller and the worm wheel 14, the reference detector 38 delivers a signal to the reference position register 46, which causes this reference position register to store the actual count value of the counter 44. The stored value is transmitted to the servo controller 48 and represents the reference position φ0. Then, when the printer is operating, the servo controller 48 monitors the changes in the count value of the counter 44 and thus determines the current position of the feed roller 12 relative to the reference position φ0.

When the sheet 18 has to be advanced by an advance step ΔS, the servo controller 48 reads from the calibration memory 50 the value of dδ/dφ that is pertinent for the current angular position of the rotary unit 10, calculates the angular displacement Δφ and outputs a control signal C, so that the motor 22 is rotated until the count value of counter 44 has changed by an amount corresponding to Δφ. In this way, the control signal C is calibrated such that the non-linearities of the function S(φ) are compensated for.

While, in the present embodiment, the calibration memory 50 stores the function dδ/dφ, it would also be possible, in a modified embodiment, to store the function δ(φ) or the function S(φ) and to derive the required A(p directly from that function.

It will further be understood that the reference detector 38 and the reference position register 46 will also be useful when the printer has been manufactured and assembled and the function dδ/d φ has to be measured and recorded in the calibration register 50.

When the printer is of a type wherein the sheet 18 is fed continuously, the control system may be modified in an evident manner so as to calibrate the sheet advance speed rather than the length ΔS of a sheet advanced step, again by reference to the calibration memory 50 and the current position of the rotary unit in relation to the reference position as detected with the detector 38.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A drive mechanism for a feed roller in a printer, which comprises:
a worm wheel provided on the feed roller and forming a rotary unit therewith,
a worm gear adapted to engage said worm wheel,
a motor for driving said worm,
an encoder for detecting incremental (δφ)angular positions of the worm, and
a servo controller operatively connected to the motor, wherein said rotary unit has a sync mark defining a reference position (φ0), a reference detector is provided for detecting the sync mark, and the servo controller has access to a calibration memory and is adapted to output a calibrated motor control signal (C) dependant on the angular position of the feed roller as determined from said reference position (φ0) and said worm angular position increments (δφ).

2. The drive mechanism according to claim 1, wherein the sync mark is provided on the worm wheel.

3. The drive mechanism according to claim 2, wherein the sync mark is formed by a gap in an annular boss formed on an end face of the worm wheel, and the reference detector is an optical detector embracing the boss.

4. The drive mechanism according to claim 1, wherein the encoder is a quadrature encoder.

5. The drive mechanism according to claim 1, including a control system which comprises said servo controller, a counter for counting pulses of the encoder, and a reference position register adapted to store a count value of said counter upon receipt of a detection signal from said reference detector.

6. An ink jet printer containing the drive mechanism of claim 1.
